(19) United States
(12) Patent Application Publication
(10) Pub. No.: US 2017/0108898 A1
(43) Pub. Date: Apr. 20, 2017

(54) ELECTRONIC DEVICE AND DISPLAY MODULE THEREOF

(71) Applicant: Acer Incorporated, New Taipei City (TW)

(72) Inventor: Chao-Di SHEN, New Taipei City (TW)

(21) Appl. No.: 15/009,104

(22) Filed: Jan. 28, 2016

(30) Foreign Application Priority Data
Oct. 20, 2015 (TW) 104134319

(51) Int. Cl. G06F 1/16

(52) U.S. Cl. CPC G06F 1/1681

(57) ABSTRACT

A display module is provided, including a display unit, a C-shaped frame, and a first hinge member. The display unit has a display surface and a rear surface, wherein the display surface and the rear surface are formed on opposite sides of the display unit. The first hinge member is pivotally connected to an end of the C-shaped frame and is fixed to the rear surface of the display unit.

### CROSS REFERENCE TO RELATED APPLICATIONS

The present application is based on, and claims priority from, Taiwan Patent Application No. 104134319, filed on Oct. 20, 2015, the disclosure of which is hereby incorporated by reference herein in its entirety.

### BACKGROUND OF THE INVENTION

Field of the Invention

The application relates in general to an electronic device, and in particular, to an electronic device having a rotatable display module.

Description of the Related Art

Referring to FIGS. 1-2, a conventional notebook computer 1 with a rotatable screen usually has a hinge member 5 pivotally connected to a frame 3 and fixed to a side 21 of a display 2 (or a tablet computer) by a screw 6. The frame 3 can be rotated relative to the input module 4, so that the viewing angle of the users can be arbitrarily adjusted. FIG. 2 is an enlarged view of the portion A in FIG. 1. As shown in FIG. 2, during assembly of the notebook computer 1, the hinge member 5 is fixed to the side 21 of the display 2 by the screw 6, such that the display 2 and the hinge member 5 are rotatable with respect to the frame 3. However, as the screw 6 and the hinge member 5 must be assembled from the side 21 of the display 2, the screw 6 and the hinge member 5 inevitably occupy the space of the display 2 and limit the size of the display 2 along the X direction. In addition, these screw 6 and hinge member 5 are exposed to the display 2 which may influence the aesthetic appearance of the notebook computer 1.

### BRIEF SUMMARY OF INVENTION

To address the deficiencies of conventional electronic products, an embodiment of the invention provides a display module including a display unit, a C-shaped frame, and a first hinge member. The display unit has a display surface and a rear surface, wherein the display surface and the rear surface are formed on opposite sides of the display unit. The first hinge member is pivotally connected to an end of the C-shaped frame and fixed to the rear surface of the display unit.

In some embodiments, the display module further comprises a fixing member, and the first hinge member having a through hole, wherein the fixing member is extended through the through hole to fix the first hinge member to the rear surface of the display unit.

In some embodiments, the display module further comprises a second hinge member pivotally connected to the C-shaped frame and fixed to the rear surface of the display unit, wherein the first hinge member and the second hinge member are adjacent to each other and disposed on opposite sides of the C-shaped frame.

In some embodiments, the display module further comprises a housing covering the first hinge member.

In some embodiments, the C-shaped frame extends through and protrudes from the housing.

An electronic device is also provided in the invention, comprising a display module and an input module, wherein the display module includes a display unit, a C-shaped frame, and a first hinge member. The display unit has a display surface and a rear surface, wherein the display surface and the rear surface are formed on opposite sides of the display unit. The first hinge member is pivotally connected to an end of the C-shaped frame and fixed to the rear surface of the display unit. The input module is pivotally connected to the C-shaped frame.

In some embodiments, the electronic device further comprises a fixing member, and the first hinge member has a through hole, wherein the fixing member is extended through the through hole to fix the first hinge member to the rear surface of the display unit.

In some embodiments, the electronic device further comprises a second hinge member pivotally connected to the C-shaped frame and fixed to the rear surface of the display unit, wherein the first hinge member and the second hinge member are adjacent to each other and disposed on opposite sides of the C-shaped frame.

In some embodiments, the electronic device further comprises a housing covering the first hinge member.

In some embodiments, the C-shaped frame extends through and protrudes from the housing.

### BRIEF DESCRIPTION OF DRAWINGS

The invention can be more fully understood by reading the subsequent detailed description and examples with references made to the accompanying drawings, wherein:

FIG. 1 is a schematic diagram of a conventional notebook computer;

FIG. 2 is an enlarged schematic diagram of the portion A in FIG. 1;

FIGS. 3A-3B are schematic diagrams of a display module according to an embodiment of the invention;

FIG. 4 is a schematic diagram of the first hinge members and the C-shaped frame in FIG. 3;

FIG. 5 is a schematic diagram of the first hinge member fixed to the rear surface of the display unit by the fixing member in FIG. 3;

FIG. 6 is an schematic diagram of the first hinge member and the second hinge member disposed at the end of the C-shaped frame according to another embodiment of the invention;

FIG. 7 is a partial cross-sectional diagram of a display module according to another embodiment of the invention;

FIG. 8 is a schematic diagram of an electronic device according to another embodiment of the invention;

FIG. 9 is a schematic diagram of a display module according to another embodiment of the invention; and

FIG. 10 is a schematic diagram of the display module in FIG. 9 when in a closed state.

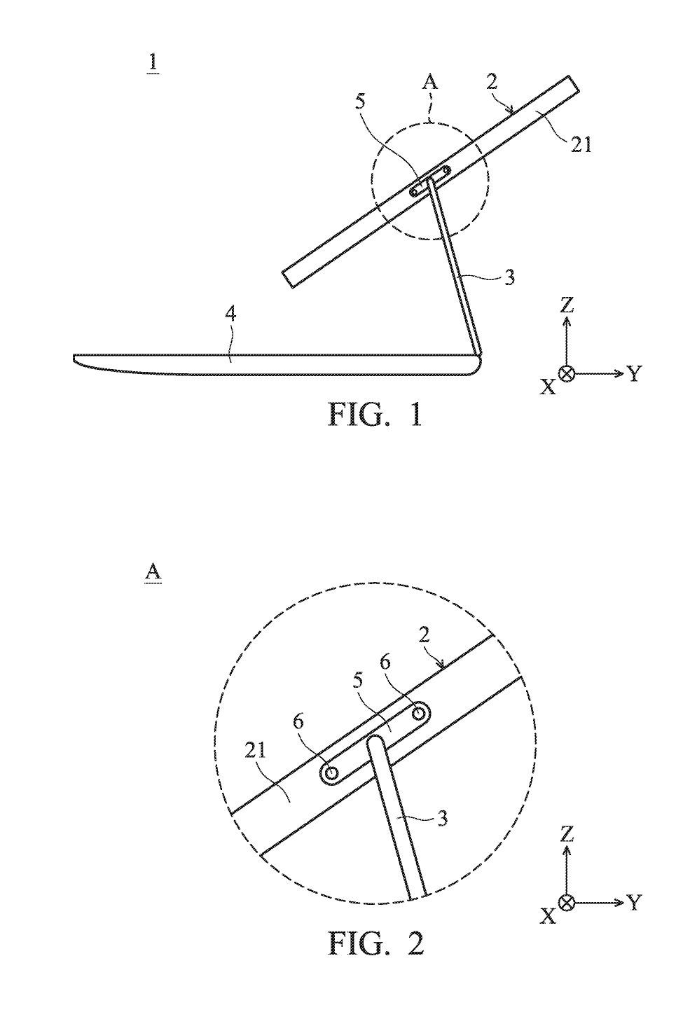

### DETAILED DESCRIPTION OF INVENTION

The making and using of the embodiments of the electronic device are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

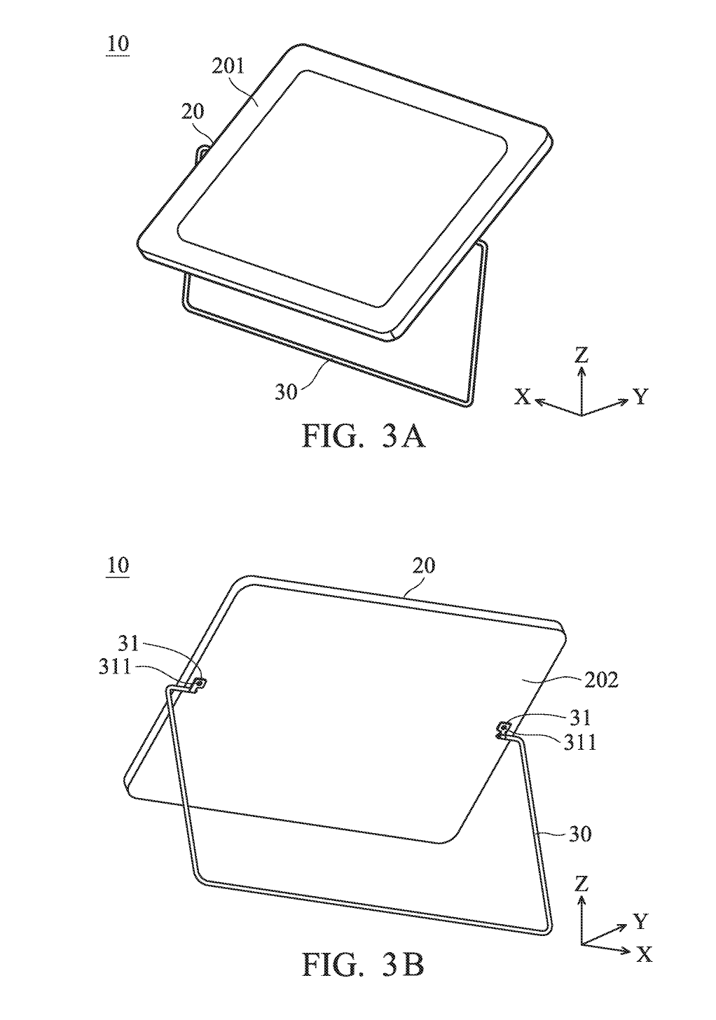

Referring to FIGS. 3A-3B, which are schematic diagrams of a display module 10 according to an embodiment of the invention. The display module 10 primarily comprises a display unit 20, a C-shaped frame 30, and two first hinge members 31. The display unit 20 has a display surface 201 and a rear surface 202 opposite to the display surface 201, wherein the first hinge members 31 are pivotally connected to the ends of the C-shaped frame 30, respectively, and are fixed to the rear surface 202 of the display unit 20. The display unit 20 and the first hinge members 31 can be rotated with respect to the C-shaped frame 30, such that the viewing angle of the users can be arbitrarily adjusted.

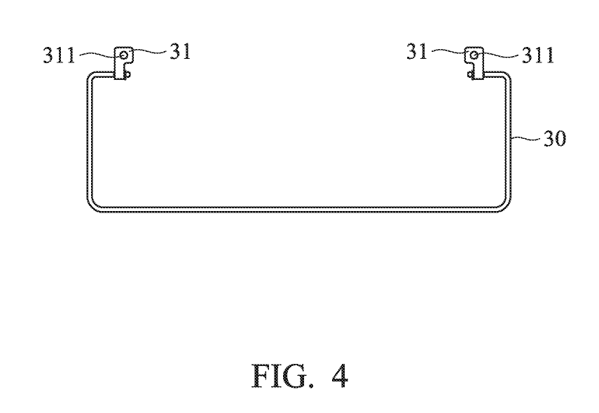

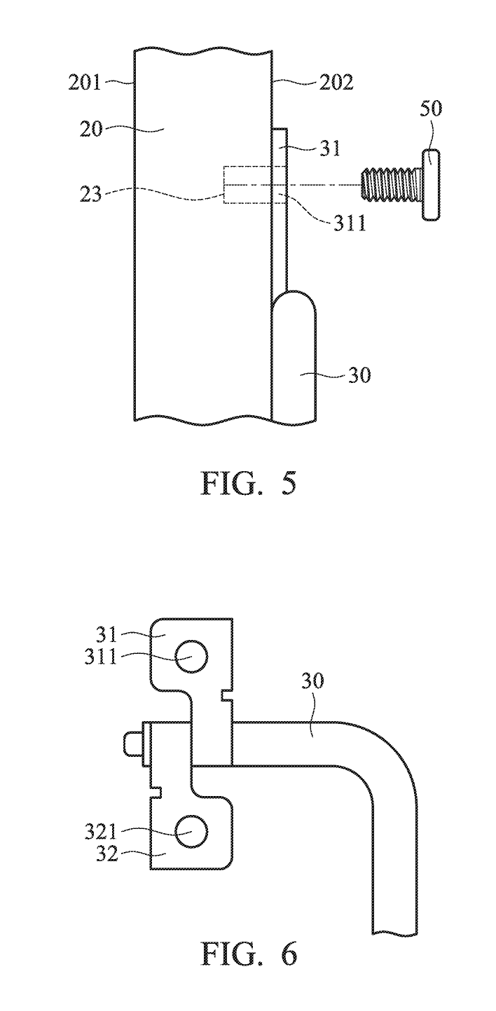

Referring to FIGS. 4-5, FIG. 4 is a schematic diagram of the first hinge members 31 and the C-shaped frame 30 in FIGS. 3A-3B, and FIG. 5 is a schematic diagram of the first hinge member 31 fixed to the rear surface 202 of the display unit 20 by a fixing member 50. As shown in FIG. 5, a recess 23 is formed on the rear surface 202 of the display unit 20, and a through hole 311 is formed on each of the first hinge members 31, corresponding to the recess 23. During assembly of C-shaped frame 30 and the display unit 20, the fixing member 50 is extended through the through hole 311 and join to the recess 23, so that the first hinge member 31 is tightly fixed to the rear surface 202 of the display unit 20.

Referring to FIG. 6, in another embodiment of the invention, a first hinge member 31 and a second hinge member 32 can be disposed at each end of the C-shaped frame 30, wherein the first hinge member 31 is adjacent to the second hinge member 32. During assembly of the C-shaped frame 30 and the display unit 20, the fixing members 50 are extended through the through holes 311 and 312. Thus, the first hinge member 31 and the second hinge member 32 are fixed to the rear surface 202 of the display unit 20, thereby enhancing the structural strength of C-shaped frame 30 and the display module 10 after assembly. In some embodiments, the first and second hinge members 31 and 32 may also have a plurality of through holes (not show), such that they can be fixed to the rear surface 202 of the display unit 20 by a plurality of fixing members 50 extended through those through holes. Furthermore, the first and second hinge members 31 and 32 adjacent each other may also be integrally formed in one piece. Similarly, the C-shaped frame 30 may also be integrally formed in one piece, so as to reduce the number of assembly parts and production cost.

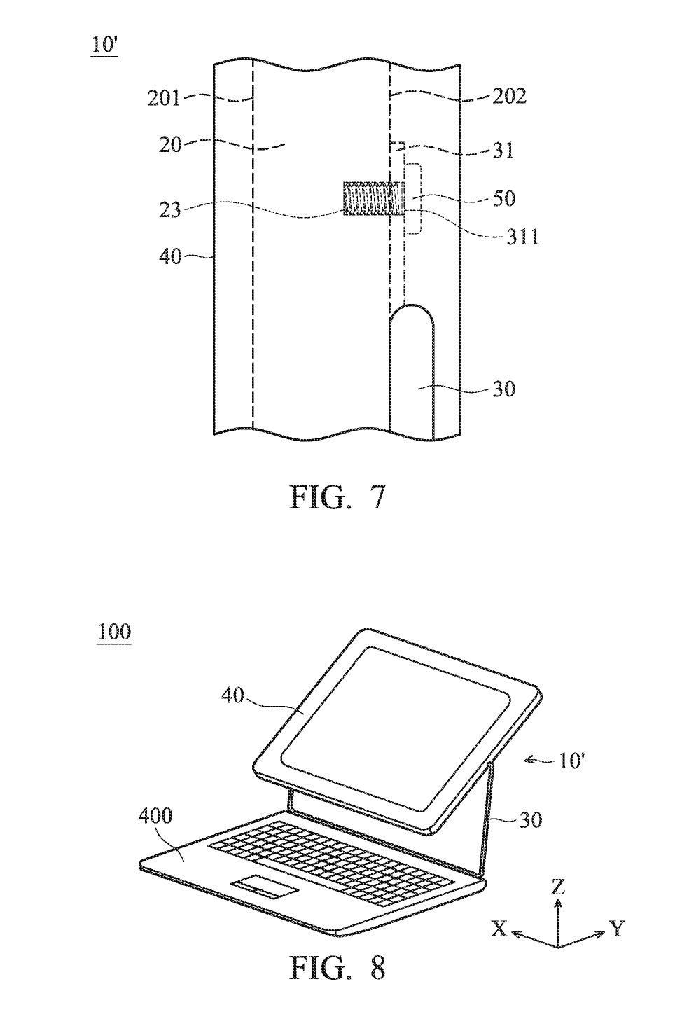

Referring to FIG. 7, FIG. 7 is a partial cross-sectional diagram of a display module 10′ according to another embodiment of the invention. The main difference between the display module 10′ in FIG. 7 and the display module 10 in FIGS. 3A-3B is that the display unit 20, the first hinge member 31 and the fixing member 50 are disposed in a housing 40. The first hinge member 31 is fixed to the rear surface 202 of the display unit 20 via the fixing member 50. The first hinge member 31 is pivotally connected to the end of the C-shaped frame 30 and is rotatable with respect to the C-shaped frame 30. It is noted that the first hinge member 31 and the fixing member 50 would not be seen from the outside of the electronic device 10′ because the display unit 20, the first hinge member 31, and the fixing member 50 are covered by the housing 40. As to the C-shaped frame 30, it extends through and protrudes from a side of the housing 40, so that the display unit 20, the first hinge member 31, and the housing 40 are rotatable with respect to the C-shaped frame 30, whereby the viewing angle of the users can be arbitrarily adjusted.

FIG. 8 is a schematic diagram of an electronic device 100 according to another embodiment of the invention. As shown in FIG. 8, the electronic device 100, for example, is a notebook which primarily comprises a display module 10′ and an input module 400, wherein a keyboard can be disposed on the surface of the input module 400. The C-shaped frame 30 is pivotally connected to the input module 400, so that the C-shaped frame 30 can be rotated with respect to the input module 400. In some embodiments, the display module 10 (as shown in FIGS. 3A-3B) could also be pivotally connected to the input module 400 via the C-shaped frame 30. However, the first hinge member 31 and the fixing member 50 would be exposed to the rear surface 202 of the display unit 20 without the housing 40.

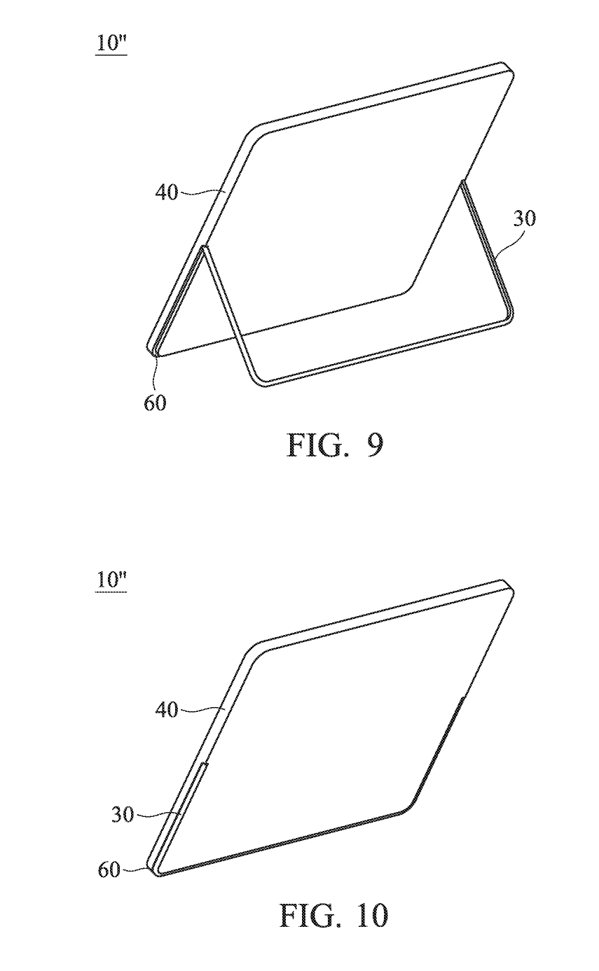

FIG. 9 is a schematic diagram of a display module 10″ according to another embodiment of the invention. As shown in FIG. 9, the display module 10″ can be a tablet computer capable of touch control. The main difference between the display module 10″ and the display module 10′ in FIG. 7 is that a C-shaped groove 60 is formed on the two sides and the bottom side of the housing 40. FIG. 10 is a schematic diagram of the display module 10″ in FIG. 9 when in a closed state. As shown in FIG. 10, when the C-shaped frame 30 of display module 10″ is in the closed state, the C-shaped frame 30 is received in the groove 60. Namely, the C-shaped frame 30 cannot be seen when viewed from the front of the display module 10″.

In summary, an electronic device and a display module thereof are provided in this invention. The display module comprises at least a display unit, a first hinge member, and a C-shaped frame. Compared to a traditional monitor having the hinge member assembled from the lateral side of the display, the first hinge member of the present invention is pivotally connected to the C-shaped frame and fixed to the rear surface of the display unit, so as to avoid adverse limitation of size along the horizontal direction of the display, and enhance the aesthetic appearance of the electronic device.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A display module, comprising:
a display unit, having a display surface and a rear surface, wherein the display surface and the rear surface are formed on opposite sides of the display unit;
a C-shaped frame; and
a first hinge member, pivotally connected to an end of the C-shaped frame and fixed to the rear surface of the display unit.

2. The display module as claimed in claim 1, wherein the display module further comprises a fixing member, and the first hinge member having a through hole, wherein the fixing member is extended through the through hole to fix the first hinge member to the rear surface of the display unit.

3. The display module as claimed in claim 1, wherein the display module further comprises a second hinge member pivotally connected to the C-shaped frame and fixed to the rear surface of the display unit, wherein the first hinge member and the second hinge member are adjacent to each other and disposed on opposite sides of the C-shaped frame.

4. The display module as claimed in claim 1, wherein the display module further comprises a housing covering the first hinge member.

5. The display module as claimed in claim 4, wherein the C-shaped frame extends through and protrudes from the housing.

6. An electronic device, comprising:
a display module, comprising:
a display unit, having a display surface and a rear surface, wherein the display surface and the rear surface are formed on opposite sides of the display unit;
a C-shaped frame;
a first hinge member, pivotally connected to an end of the C-shaped frame and fixed to the rear surface of the display unit; and
an input module, pivotally connected to the C-shaped frame.

7. The electronic device as claimed in claim 6, wherein the electronic device further comprises a fixing member, and the first hinge member has a through hole, wherein the fixing member is extended through the through hole to fix the first hinge member to the rear surface of the display unit.

8. The electronic device as claimed in claim 6, wherein the electronic device further comprises a second hinge member pivotally connected to the C-shaped frame and fixed to the rear surface of the display unit, wherein the first hinge member and the second hinge member are adjacent to each other and disposed on opposite sides of the C-shaped frame.

9. The electronic device as claimed in claim 6, wherein the electronic device further comprises a housing covering the first hinge member.

10. The electronic device as claimed in claim 9, wherein the C-shaped frame extends through and protrudes from the housing.
